(19) United States
(12) Patent Application Publication
(10) Pub. No.: US 2002/0080789 A1
(43) Pub. Date: Jun. 27, 2002

(54) Switch-based network processor

(76) Inventors: Alex E. Henderson, Hillsborough, CA (US); Walter E. Croft, San Mateo, CA (US)

Correspondence Address: FENWICK & WEST LLP, TWO PALO ALTO SQUARE, PALO ALTO, CA, 94306, US

(21) Appl. No.: 10/005,596

(22) Filed: Nov. 7, 2001

Related U.S. Application Data
(60) Provisional application No. 60/246,790, filed on Nov. 7, 2000.

(51) Int. Cl. H04L 12/56

(52) U.S. Cl. 370/392; 370/401

(57) ABSTRACT

A switch-based network processor disclosed. The switch-based network processor includes a packet parser, search and modification scheduler that parses a data packet, develops a search for a processing rule associated with the packet, and schedules a modification to be performed on the packet based on the rule. The processor also includes several search resources that each can search simultaneously for a processing rule. Multiple packet modifiers are included to modify several packets simultaneously. A core switch is also provided to switch search requests from the parser to the search resources, to switch search responses from the search resources to the parser, and to switch modification requests and responses between the parser and packet modifiers. The switch-based processor also includes a session state storage device that can be used to allow the processor to be aware of a session.

### CROSS REFERENCE TO RELATED APPLICATION

This application claims priority under 35 U.S.C. §119(e) from co-pending Provisional Application No. 60/246,790, entitled “Switch Based Network Processor” filed on Nov. 7, 2000, which is fully incorporated herein by reference.

### FIELD OF THE INVENTION

The invention is related to the field of network processing, and in particular to the fields of network routers, firewalls, bandwidth managers, and switches.

### BACKGROUND OF THE INVENTION

Current computer communications systems transfer data from one computer to another using a network such as the Internet for example. Data that is transferred is divided into smaller blocks of data called packets. Each packet is placed onto the network by a transmitting computer, where it is processed by one or more routers or switches that receive the packet and determine an address indicating where the packet needs to be sent so that it can be received by an appropriate receiving computer. A router determines the appropriate destination address by sending a search request to a search engine or content addressable memory (CAM) via a bus. However, the processing time needed by the router to find an address for a packet is limited by the bandwidth of the bus.

Increasing the bandwidth available for address searches requires a replacement to this conventional bus that connects the router to the search engines. Furthermore, performing a large variety of modifications to the packet at the router requires access to packets by the router at rates that are currently unavailable. Also, access to a session/state memory, so that the router can be session aware, is not possible with conventional routers that have limited bandwidth. One architecture solution to the bandwidth-limited bus problem uses a Multi-CPU (central processing unit) network processor. However, this solution is too slow to adequately perform address searches, and does not scale very well. A shared memory solution to this problem is inadequate because it is limited by memory bandwidth. A solution that uses many special purpose processors is undesirable because the processors are hard to connect and program.

### SUMMARY OF THE INVENTION

A switch-based network processor is disclosed. The switch-based network processor includes at least one packet parser, search, and modification scheduler that parses a data packet, develops requests for search engines, and schedules a modification to be performed on the packet based on the results of the searches. The processor also includes several search resources that each can perform multiple searches simultaneously. Multiple packet modifiers are included to modify several packets simultaneously. A core switch is also provided to switch search requests from the parser to the search resources, to switch search responses from the search resources to the parser, and to switch modification requests and responses between the parser and packet modifiers. The core switch may also switch packet data into and out of a packet buffer memory in response to packet reception, a schedule for transmit operations, or instruction based access to packet contents. Search requests and modification requests may be included in instruction packets. An instruction packet may also contain packet data or indirect references to packet data via packet pointers. In one embodiment, packet pointers include a packet identifier unique to each packet currently in the switch-based network processor, and an offset that specifies a location in a packet. The switch-based processor may also include a session state storage device and session/state access instructions that can be used to allow processing of packets to be dependent on session and state variables associated with a group of packets, e.g. the packets that are included in a transmission control protocol (TCP) session.

### BRIEF DESCRIPTION OF THE DRAWINGS

The present invention is illustrated by way of example and not limitation in the figures of the accompanying drawings, in which like references indicate similar elements, and in which:

FIG. 1 shows an example of one embodiment of a switch-based network processor.

FIG. 2 shows an example of one embodiment of session state storage that is used to identify a session.

FIG. 3 shows an example of one embodiment of a core switch used by the switch-based network processor.

FIG. 4 illustrates one embodiment of the search response resolution mechanism.

FIG. 5 shows an example of one embodiment of a method for state based packet processing.

FIG. 6 shows an example of one embodiment of a method to process a packet using the switch-based network processor.

### DETAILED DESCRIPTION

A switch-based network processor is disclosed. The switch-based network processor includes a packet parser, search and modification scheduler that parses a data packet, develops a search for a processing rule associated with the packet, and schedules a modification to be performed on the packet based on the rule. The processor also includes several search resources that each can search simultaneously for a processing rule. Multiple packet modifiers are included to modify several packets simultaneously. A core switch is also provided to switch search requests from the parser to the search resources, to switch search responses from the search resources to the parser, and to switch modification requests and responses between the parser and packet modifiers. The switch-based processor also includes a session state storage device that can be used to allow the processor to be aware of a session.

The switch-based network processor includes caching associative memories as search resources so that a large policy database can be used by the switch to process packets. One example is described in U.S. application Ser. No. 09/636,304 entitled “Caching Associative Memory,” filed on Aug. 10, 2000, which is fully incorporated herein by reference. For example, very large routing tables can be implemented in the same system that implements policy using the switch-based processor. Also, session aware (stateful) applications can be addressed, so that a session or state can be identified and maintained across multiple packets, i.e., the processor can be session aware. Additional modification features may be performed using the switch-based processor. For example, multi-protocol label switching (MPLS), push, pop, merge, time to live (TTL) decrement, and Internet protocol (IP) checksum recalculate modifications may be executed. Also, encryption extensions that use modification for IPSEC (IP security) “mutable” fields, support for source routing, and IP checksum recalculation, may be performed by the switch-based processor. The processor may also use tools for IP fragmentation and re-assembly to perform encryption or uniform resource locator (URL) switching. Multiple searches per packet and complex packet searches can be performed. Additional features that may be supported by the processor include URL search and multi-field extraction functions. The switch-based network processor can also support complex applications at high rates, such as an OC-192 rate, for example. Thus, the switch-based network processor may be used to improve performance of a router, a firewall, a bandwidth manager, a switch, or a line card.

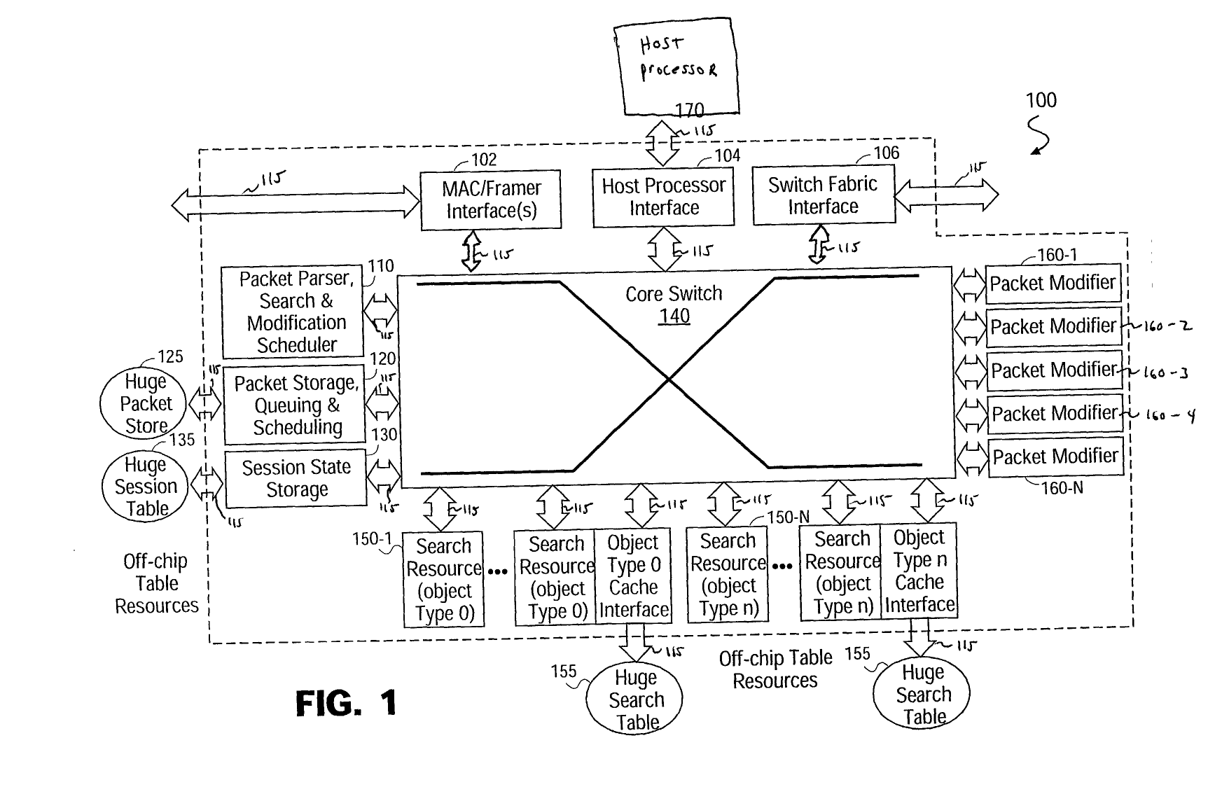

An example of one embodiment of a switch-based network processor 100 is shown in FIG. 1. The processor 100 receives a packet from an input line of a network, such as a local area network (LAN) or wide area network (WAN) for example, through network interface 102, which may be a MAC or Framer interface for example. The interface 102 sends the packet through core switch 140 to packet parser, search, and modification scheduler 110. The parser 110 issues a search request through the core switch 140 to the search resources 150 to locate appropriate processing rules for the packet. The packet parser 110 may also assign a packet identifier (ID) to the packet and forward it to the packet storage device 120. The search resources 150 produce one or more search responses to the search request, and send the responses to core switch 140. The core switch 140 passes the responses to the packet parser 110. The packet parser 110 issues one or more packet modification requests based on the search responses, and sends the modification requests through the core switch 140 to the packet modifiers 160. Each packet modifier 160 is configured to modify the packet by applying the instructions corresponding to the modification requests to the packet, as discussed below, and to send the modified packet back to parser 110 or to the packet storage device 120 through switch 140. The packet storage device 120 receives the modified packet and sends the modified packet through core switch 140 to switch fabric interface 106, which sends the packet out of the switch-based network processor 100 to a switch fabric that switches the packet to an appropriate output line of the network. The host processor interface 104 provides an interface between a host processor 170 and the switch-based processor 100, so that the host processor 170 may control the switch-based processor 100. For example, the host processor 170 may provide information to the switch-based network processor 100 so that the switch-based network processor can adequately process exception packets. Interface devices 115 allow the components of processor 100 to send and receive data.

The switch-based processor 100 can parse packets by extracting information from packets based on complex rules. The processor can classify packets by looking up data extracted from packets. Also, the processor can tag, or apply labels, to packets by inserting or over-writing data contained in the packets. For example, packet parser 110 receives a packet. The parser 110 performs one or more parsing and classification operations on the packet. A parsing operation may be used by the parser to locate a session identifier for the packet, and a classification operation may use the session identifier to determine whether the packet belongs to an existing session. A session is a group of packets that are transmitted from one computer to another over a network. The session may have packets associated with a beginning portion that are used to establish a connection between the two computers. For example, the beginning portion may be used to identify the transmitting computer, so that packets from the transmitting computer can pass through a firewall and be received by the receiving computer. The session may also have packets associated with a middle portion of the session. These packets may contain the data that is transmitted to the receiving computer. The session may also have packets associated with an end portion that are used to end the connection between the two computers.

A session identifier may be included in each packet. The parser 110 locates the session identifier, reads the identifier data, and compares the identifier data with session identifiers that are stored in session storage devices 130 and 135. If the identifier of the received packet matches an identifier in one of the storage devices 130 or 135, the parser 110 determines that the packet belongs to the session associated with the matched identifier in the database. If the session identifier for the packet does not have a match in the session storage database, the packet may auto-create a new session. Alternatively, after the host processor 170 is notified of the exception (the non-matching session identifier) by the switch-based network processor 100, the host processor 170 may create a new session associated with the session identifier. In many protocols (e.g. TCP/IP), sessions are identified by a combination of multiple fields. The source and destination IP addresses and TCP port numbers, for example, may identify a TCP/IP session. Session identification therefore includes multi-field extraction and lookup of the resulting combined data.

For example, when a packet is received, a number of session independent classification operations are performed (extract/lookup) to determine which session the packet belongs to. Each packet will either be part of a new session (unknown results of lookup), or part of an existing session. New session packets can either auto-create a session context, or be stalled while the host processor 170 creates a new session. The switch-based network processor 100 may perform an automatic creation of a new session by maintaining a table or list of available session/state database entries, and assigning a session index that can be used to access a session/state database, so that a new session is created without contacting the host processor 170. The host processor 170 may create a new session after the host processor receives a message that includes the non-matching session identifier from the switch-based network processor 100. The host processor 170 compares the non-matching session identifier with a database of sessions that may pass through the switch-based network processor 100 to the destination address. If the session identifier corresponds to a session that is allowed to pass through the switch-based network processor 100, the host processor 170 sends instructions to create a new session to the switch-based network processor 100.

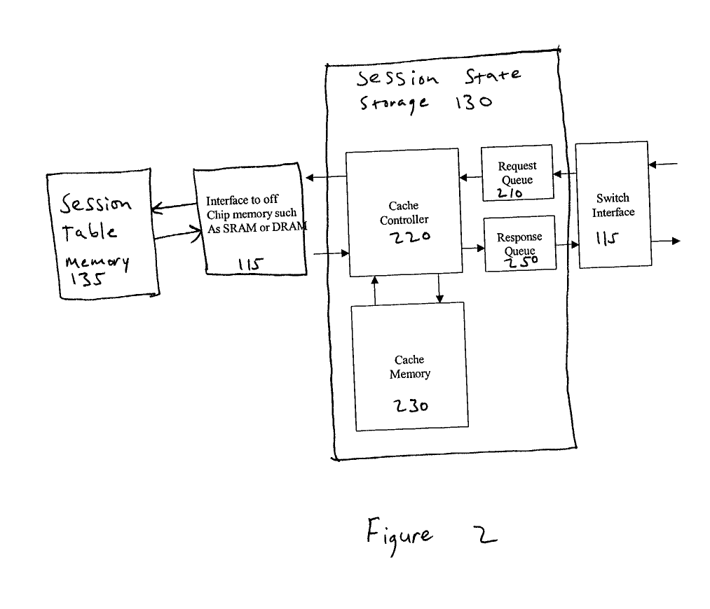

FIG. 2 shows an example of one embodiment of session state storage that is used to identify a session. Switch interface 115 receives a request to identify a session from the core switch 140. The request is stored by request queue 210 until cache controller 220 of session state storage 130 can process it. The cache controller searches cache memory 230 for a session that matches the search request. If a match is found, the matching information is sent from memory 230 to controller 220. If no match is found, the controller searches session table 135, which is stored in off-chip memory, through memory interface 115 to determine whether a session in the session table matches the search request. If a match is found, the matching information is sent to controller 220. Controller sends matching information from cache 230 or table 135 to response queue 250, which then sends the information to parser 110 through switch 140.

Session awareness is addressed by the switch-based network processor by providing a mechanism for the storage of state/next state tables 135 describing session state based behavior, and by creating and destroying session state data stored in device 130. The session/state storage may be added independently of packet storage. Allowing the processor 100 to be aware of a session permits the processor 100 to execute instructions to access and modify session/state storage device 130, thus providing the processor with a mechanism for allocating and freeing session/state storage. For example, increment and add instructions may also be executed to maintain session statistics. Also, instructions to change state may be performed by the processor 100 (e.g., Session→state=connected;). Because the processor 100 is session aware, the processor can examine a state as part of the classification process (e.g., if state equals x, then do y). For example, a session identifier can be used by the parser 1 0 to allow a packet to pass through a firewall device that contains the switch-based network processor 100 by determining that the session corresponding to the packet's session identifier has permission to pass through the firewall.

The parser 110 may further classify the packet based on the content of the packet. The parser 10 may use one or more rules to locate information in the packet and to extract the information from the packet. Further processing of packets is controlled by one or more processing policy rules associated with the information from the packet. Each processing rule may be a session state machine, which is a case statement based on session variables and packet contents. Session state machines may also include instructions describing packet modifications and operations on session variables. Support for nested sessions (e.g., TCP over IP) may be provided by a go to and a call/return mechanism.

After the parser 110 locates and extracts information from the packet, the parser may then develop a search request to find a processing rule associated with the extracted information, in order to further process the packet. The search request for this packet, or object type, is sent through core switch 140 to one or more search resources 150-1 through 150-n for the object type. Each search resource 150 can search through at least a portion of a large table of rules 155 to find an appropriate rule based on the search request. A caching interface system 151 for search memories such as a content addressable memory (CAM) cache, may be used by each search resource 150 so that the resource may perform as a very large statistically fast search system. One example is described in U.S. application Ser. No. 09/636,304 entitled “Caching Associative Memory,” filed on Aug. 10, 2000, which is fully incorporated herein by reference. Another example is described in U.S. application Ser. No. 09/231,284 filed on Jan. 15, 1999, now U.S. Pat. No. 5,999,435, entitled “Content Addressable Memory Device,” which is fully incorporated herein by reference.

After the processing rule having the highest priority is found, the instruction data associated with the rule, and the priority of the rule, are sent from search resource 150 through switch 140 to the parser 110. If multiple search resources respond with different priorities, the core switch passes the highest priority response to the packet parser 110. The processing rule may include one or more modifications to be performed on the packet. For example, the rule may include logic that indicates a field to be added or deleted from a packet. This insertion or deletion logic may be used to encapsulate or decapsulate packets, change URLs, change IP addresses, or change port numbers. The logic, when executed, can cause a packet to be encapsulated.

By coupling the concept of a packet bias variable that defines a packet based offset to effect field extractions, with the concept of an encapsulation, each packet (while being processed) may be associated with a number of session storages areas, one bias variable, and one session/state data block for each encapsulation. Thus, a file transfer protocol (FTP) over TCP over IP packet would have three session data blocks in session storage, one for each encapsulation. Each encapsulation may be associated with a separate bias and with separate state variables, which allow the processor 100 to process each encapsulation separately.

The processing rule may also contain associated data that specifies a function, such as copy a packet or a part of a packet, split a packet, or merge packets for example. Packet copying is useful for multicast replication and broadcast functions in bridges. The merging and splitting functions can be used for IP segmentation and reassembly.

The processing rule may also specify a function to generate a new packet by copying a packet template and then modifying the copy may be used to create a new packet. The processing rule may also have a function that increments or decrements a value of a field in a packet, or recalculates a checksum value.

The processing rule and the corresponding packet may be sent from the parser 110 to a packet modifier 160 through the switch 140. The packet modifier 160 modifies the contents of the packet based on the processing rule, and returns the modified packet to the parser 110 through the switch 140. If the packet requires further processing, the parser may schedule an additional search or an additional modification to the packet.

Thus, the packet modifiers, or hardware editing blocks, 160-1 through 160-n of the switch-based network processor 100 are used to address specific packet modification problems. The modifications addressed by the hardware editing blocks 160 allow the processor to remove most of the “heavy lifting” from the slow path processor 170, because processing rules can be executed by blocks 160 to modify packets. For example, the hardware blocks 160 may include field insertion/deletion logic, which can be used to encapsulate and de-capsulate packets, change URLs and IP addresses and port numbers. The editing blocks 160 may also perform functions to copy packets and parts of packets, split packets and merge packets, which is the basis for IP segmentation and re-assembly. Copying a packet template and then modifying the copy may be performed by the hardware editing blocks 160, and is the basis for creating packets. The blocks 160 may also perform modification functions for incrementing and decrementing fields in packets and recalculating checksums. A slow path processor 170 connected to slow path interface 104 may be used to handle exception packets.

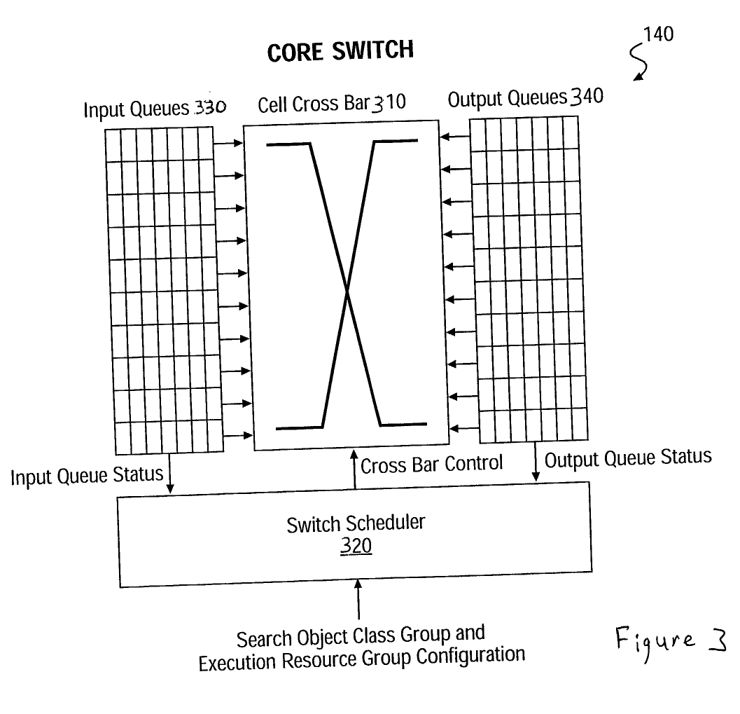

FIG. 3 shows an example of one embodiment of a core switch 140 used in the switch-based network processor 100. The core switch 140 used by the processor may include a switch fabric, such as a time division multiplex (TDM) cell crossbar 310, for example. The core switch 140 also includes an input queue device 330 to receive elements such as data packets and other information from other parts of the processor 100. The status of each element in input queue 330 is sent to switch scheduler 320. Switch scheduler 320 includes logic, such as a processing device for example, that is configured to take the input queue status for each element, and schedule an appropriate destination and time for the element to pass through crossbar 310. The switch 140 also includes an output queue device 340 that also receives data elements from other network devices, and sends the output queue status of each element to scheduler 320. The switch scheduler 320 causes the data in output queue 340 to pass through crossbar 310 at an appropriate location and time.

The core switch 140 can perform a search multi-cast feature using switch scheduler 320 that knows which switch ports are connected to a specific object type search resource 150. The search requests for a particular object type are multi-cast to these search resources 150. The switch receives the responses from the resources, and the switch scheduler 320 causes the highest priority response to be returned to the parser 110. Special features of core switch 140 are accessed using message classes. The packet parser, search and modification scheduler 110 generates messages to the various search and modification resources 150 and 160. A switch search request feature is a multicast to a search type (object type), and allows multiple search devices to run a search in parallel. A search request may contain a search sequence number used to coordinate multiple search responses. A switch search response is determined when the search devices of a specific type send a response to the search (even if they contain no relevant data) to the switch 140. The switch collects the responses, and resolves priority among responses that share a common search request sequence number.

For example, the parser 110 sends a search request to switch 140, where the request is received and stored by switch input queue 330 until switch scheduler 320 causes the request to pass from queue 330 to one or more search resources through crossbar 310. The switch may multicast the search request to multiple search devices 150, so that the devices can run the search in parallel. A search identifier, such as a search sequence number, may be included with the search request.

Each search device 150 that receives the search request performs a search based on the request and determines a search response. The search device 150 may be a CAM cache device that performs a memory content search to find a response. The search identifier may also be included with the search response. The response, along with the identifier, is sent to the switch output queue 340. The switch scheduler 320 uses the identifier to identify and collect the responses for a given search. After the output queue 340 receives the responses for a given search, the switch scheduler 320 may resolve priority among the multiple search responses, and send the response with the highest priority to the parser through crossbar 310.

For example, a match value may be associated with each response, where the match value indicates a degree of similarity between the search request and the search response. The response associated with the highest match value may be the highest priority response.

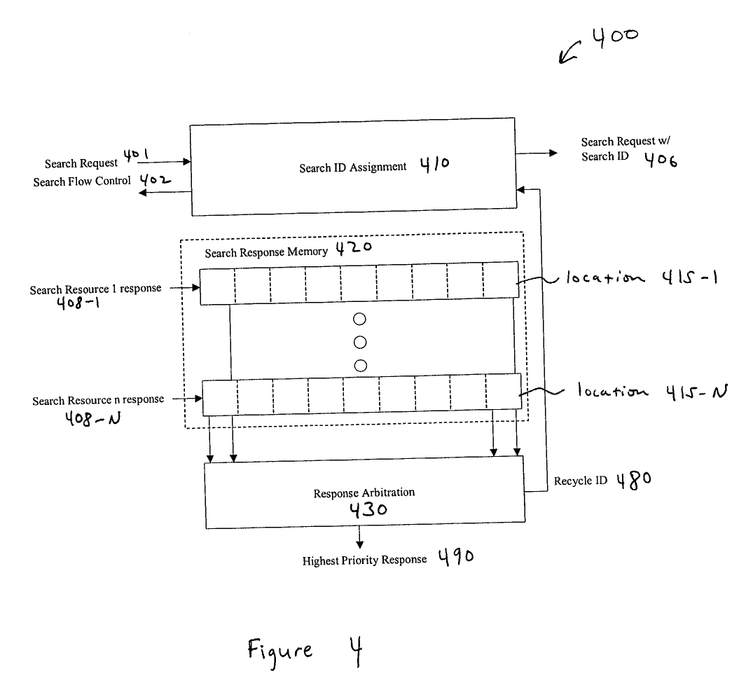

FIG. 4 illustrates one embodiment of the search response resolution mechanism 400 of the switch scheduler 320. Each search request 401 is assigned a search identifier (ID), such as a sequence number for example, from a pool of search IDs stored in search ID assignment device 410. The number of search IDs may be used to limit the maximum number of search requests that can be issued without a search response. When there is no search ID available for a new search request in assignment device 410, the search flow control signal 402 is asserted to prevent the parser 110 from sending more requests to device 400. The search ID is passed to the search resources 150 as part of the search request 406 from device 400. The search resources 150 also return the search ID as part of the search response. When the device 400 in core switch 140 receives a search response 408-N, the response is stored in the search response memory location 415-N of memory 420 addressed by the search resource number and the search ID. When a given amount of the responses for a search ID are present in the memory 420, a response is ready to be selected by response arbitration device 430. For example, when all of the search responses for a given search ID are received by the memory, the device 430 selects the response with the highest priority 490. If one or more responses are ready for arbitration, the highest priority response for the oldest response ready for arbitration is returned to the parser 110 and the corresponding search ID is recycled back to assignment device 410 using recycle ID signal 480.

The switch 140 may also receive an execution request, including a packet or packet fragment, from the parser 110. Special features of core switch 140 are accessed to perform the execution request using message classes. An execution request (with packet or packet fragment) is a unicast message that may support a load-balancing scheme. For example, the message may be sent to the execution resource 160 with the shortest input queue. The message may contain a packet fragment to be modified or may contain the entire packet. The load-balancing function can be used to scale to higher data rates, so that multiple parallel processing execution resources 160 can be added to increase speed. Because the load-balancing can be based on a modified backpressure mechanism, messages requesting a processing action can be sent to the processing resource 160 with the shortest input queue.

For example, the switch 140 may receive an execution request from the parser 110 at input queue 330. The scheduler 320 may identify an execution resource 160 with a small queue of requests that is available to perform the execution request. The switch scheduler may detect an amount of data in an input queue for each execution resource 160. The execution resource having the least amount of data in its input queue may be identified as the execution resource with the shortest input queue. This identified execution resource may then receive the execution request from the switch when scheduler 320 causes the request to pass through cross bar 310 to the identified execution resource 160.

After an execution resource 160 performs the request on the packet or packet fragment, the resource sends the response to the switch output queue 340. The response from the execution resource includes the modified packet or modified packet fragment. An execution response (with packet fragment) is the result returned by an execution unit 160. Execution responses may be used as part of the queuing and output mechanism 120. The response to a queuing or output request allows the packet parser, search and modification scheduler to recycle packet buffer resources in packet storage device 120. Thus, the execution response may indicate a queue location and schedule time for a packet received by packet storage 120.

If the packet does not require further processing, the packet may be sent to a packet output queue in packet storage 120 from parser 110 through switch 140. Packet ordering is controlled by session specific variables. Instructions may be provided to lock and un-lock sessions. Packets being processed for a locked session may be suspended when their process attempts to perform a lock instruction. Suspended packets are queued in a session lock queue in packet storage 120 in the order they attempted to lock the session. The next packet in a session lock queue may be restated when the current packet executes an unlocked instruction. A session lock queue may use a timer function. A timer expiration function provides a separate (not packet driven) entry point to a session state machine. Instructions may be provided to create a session lock queue, re-order packets in a lock queue, flush a lock queue, and destroy a lock queue. When a session lock queue is flushed, the packets are dropped, transferred to an output queue, or scheduled for further processing.

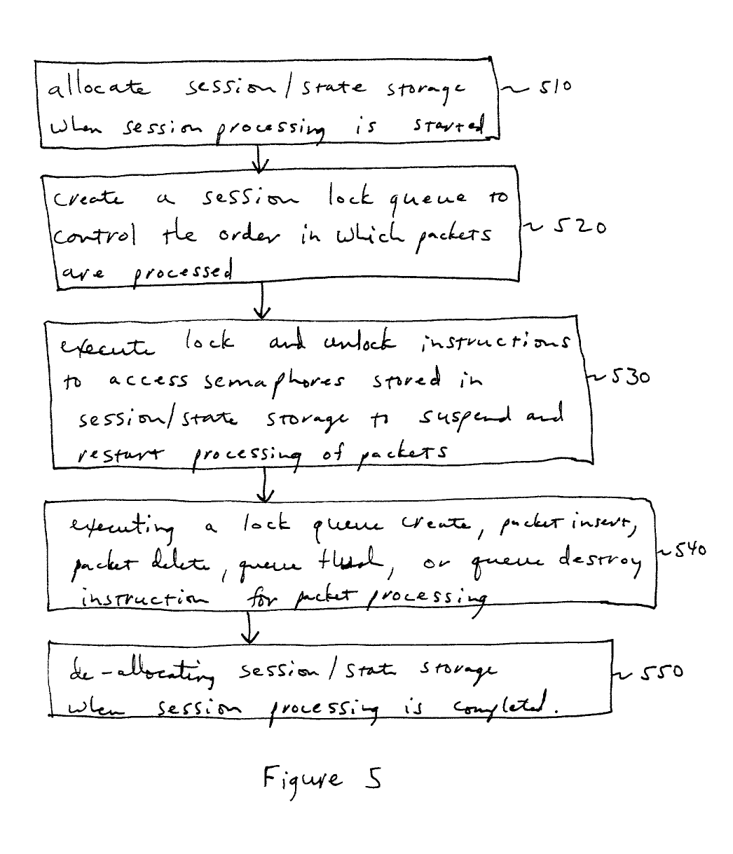

FIG. 5 shows an example of one embodiment of a method for state based packet processing. Session/state storage is allocated when session processing is started, 510. A session lock queue is created to control the order in which packets are processed, 520. Lock and unlock instructions are executed to access semaphores stored in the session state storage to suspend and restart processing of packets, 530. A packet processing instruction, such as lock queue create, packet insert, packet delete, queue flush, or queue destroy, for example, is executed for processing of packets, 540. Session/state storage is de-allocated when session processing is completed, 550.

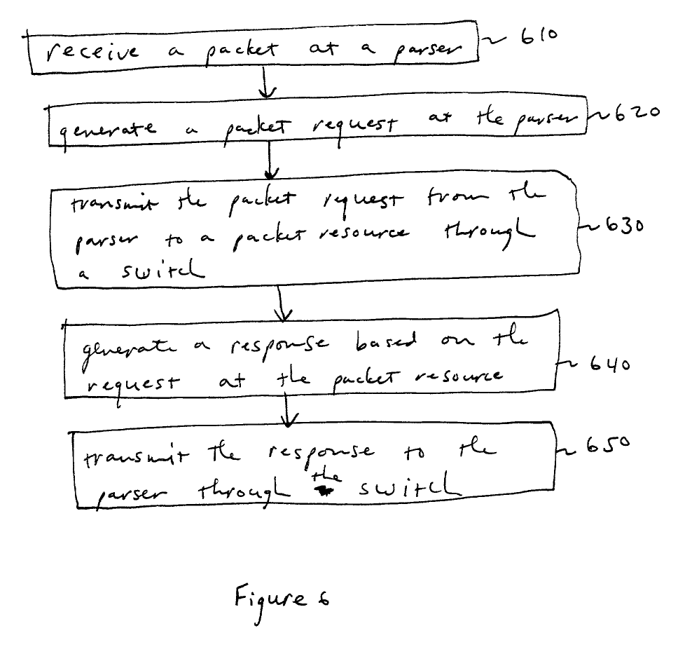

FIG. 6 shows an example of one embodiment of a method to process a packet using the switch-based network processor. A packet is received at a parser, 610. A packet request is generated at the parser, 620. The packet request is transmitted from the parser to a packet resource through a switch, 630. A response is generated at the packet resource based on the request, 640. The response is transmitted to the parser through the switch, 650. The packet request may be a packet search request, a packet modification request, or a session identification request. The packet response may be a search response, a packet modification, or a session identifier. The packet resource may be a packet modifier, a packet search device, or a session device, as described above.

A switch-based network processor has been described. The switch-based network processor allows users to implement millions of database entries without spending thousands of dollars in silicon and large board areas. The switch-based replacement for the expansion bus increases the bandwidth for searches, and allows a large variety of packet modifications that require higher bandwidth access to packets to be executed. Also, access to session/state memory, which requires a very high bandwidth, is a feature of the switch-based processor. Switch-based interconnection of simple processing units with a session aware parser/classifier acting as a rule based instruction scheduler can be scaled like a switch fabric.

These and other embodiments of the present invention may be realized in accordance with the teachings described herein and it should be evident that various modifications and changes may be made in these teachings without departing from the broader spirit and scope of the invention. The specification and drawings are, accordingly, to be regarded in an illustrative rather than restrictive sense and the invention measured only in terms of the claims.

We claim:

1. An apparatus comprising:
a parser to receive a packet and to generate a packet search request;
a plurality of search resources, each search resource to determine a search response to the packet search request; and
a switch to receive the packet search request from the parser and to multicast the packet search request to the plurality of search resources.

2. The apparatus of claim 1, wherein the switch is further configured to receive a search response from each of the plurality of search resources, to select one search response from the received search responses, and to transmit the selected response to the parser.

3. The apparatus of claim 2, wherein the parser is further configured to generate a modification request for the packet based on the search response.

4. The apparatus of claim 3, further comprising a plurality of packet modifiers, each packet modifier configured to modify the packet using the modification request.

5. The apparatus of claim 4, wherein the switch is configured to transmit the modification request from the parser to a packet modifier having a shortest queue.

6. The apparatus of claim 5, wherein the switch is further configured to transmit the modified packet from the packet modifier to the parser.

7. An apparatus comprising:
a parser to receive a packet and to generate a packet request;
a plurality of packet resources, each packet resource to generate a packet response based on the packet request; and
a switch to receive the packet request from the parser and to transmit the packet request to at least one of the plurality of packet resources.

8. The apparatus of claim 7, wherein the packet request is selected from the group consisting of: a packet search request, a packet modification request, and a session identification request.

9. The apparatus of claim 7, wherein the switch is further configured to receive a packet response from at least one of the plurality of packet resources, and to transmit the packet response to the parser.

10. The apparatus of claim 9, wherein the packet response is selected from the group consisting of: a search response, a packet modification, and a session identifier.

11. The apparatus of claim 9, wherein the packet resource is selected from the group consisting of: a packet modifier, a packet search device, and a session device.

12. An apparatus comprising:
first means for receiving a packet and for generating a packet request;
second means for generating a packet response based on the packet request; and
third means for receiving the packet request from said first means and for transmitting the packet request to said second means.

13. The apparatus of claim 12, wherein the packet request is selected from the group consisting of: a packet search request, a packet modification request, and a session identification request.

14. The apparatus of claim 12, wherein said third means further comprises means for receiving a packet response from said second means, and for transmitting the packet response to said first means.

15. The apparatus of claim 12, wherein the packet response is selected from the group consisting of: a search response, a packet modification, and a session identifier.

16. The apparatus of claim 12, wherein said second means is selected from the group consisting of: a packet modifier, a packet search device, and a session device.

17. A method comprising:
receiving a packet at a parser;
generating a packet request at the parser; and
using a switch to transmit the packet request from the parser to a packet resource.

18. The method of claim 17 further comprising:
using the packet resource to generate a packet response based on the packet request.

19. The method of claim 17, wherein the packet request is selected from the group consisting of: a packet search request, a packet modification request, and a session identification request.

20. The method of claim 17 further comprising using the switch to transmit the packet response from the packet resource to the parser.

21. The method of claim 17, wherein the packet response is selected from the group consisting of: a search response, a packet modification, and a session identifier.

22. The method of claim 17, wherein the packet resource is selected from the group consisting of: a packet modifier, a packet search device, and a session device.

23. A method for state based packet processing comprising:
allocating session/state storage when session processing is started;
creating a session lock queue to control the order in which packets are processed;
executing lock and unlock instructions to access semaphores stored in the session state storage to suspend and restart processing of packets;
executing an instruction for processing of packets selected from the group consisting of: lock queue create, packet insert, packet delete, queue flush, and queue destroy; and
de-allocating session/state storage when session processing is completed.
